(19) United States
(12) Patent Application Publication
(10) Pub. No.: US 2024/0248950 A1
(43) Pub. Date: Jul. 25, 2024

(54) HYBRID ANALOG-DIGITAL MATRIX PROCESSOR AND RELATED METHOD FOR PERFORMING FOURIER TRANSFORM

(71) Applicant: Lightmatter, Inc., Boston, MA (US)

(72) Inventors: David Widemann, Danville, CA (US); Bradford Turcott, Georgetown, TX (US); Darius Bunandar, Boston, MA (US); Nicholas C. Harris, Menlo Park, CA (US); Eric Hein, Atlanta, GA (US); Alexandra Wleklinski, Los Gatos, CA (US)

(73) Assignee: Lightmatter, Inc., Boston, MA (US)

(21) Appl. No.: 18/390,329

(22) Filed: Dec. 20, 2023

Related U.S. Application Data
(60) Provisional application No. 63/434,186, filed on Dec. 21, 2022.

(51) Int. Cl. G06F 17/14

(52) U.S. Cl. CPC G06F 17/142

(57) ABSTRACT

Hybrid analog-digital processors and related methods are described. A hybrid analog-digital processor or related method may carry out an algorithm for efficiently performing a Fourier Transform with lower power consumption and higher speed compared with fully-digital processors. A hybrid analog-digital processor or related method may use a digital processor to perform some portions of a Fourier Transform, such as sizing signals for input into an analog accelerator (such as a photonic accelerator). The analog accelerator may be configured to perform some portions of the Fourier Transform by performing matrix-vector multiplication on the sized signals using light. Further efficiency may be provided by in some environments by batching signals that are input into the analog accelerator into 2D arrays, or by performing matrix-vector multiplication using a submatrix of a full Fourier Transform matrix.

### RELATED APPLICATIONS

This application claims the benefit under 35 U.S.C. § 119(e) of U.S. Provisional Patent Application Ser. No. 63/434,186, filed Dec. 21, 2022, and titled “HYBRID-ANALOG-FFT,” which is hereby incorporated herein by reference in its entirety.

### BACKGROUND

Fully-digital processors may perform Fourier Transforms using a high number of computations. The Fourier Transform is a mathematical technique that transforms a function of time (or space) into a function of frequency. The Fourier Transform is widely used in various fields such as signal processing, communications, image analysis, and quantum mechanics. In simpler terms, the Fourier Transform allows representation of a signal in terms of its constituent frequencies. It decomposes a complex signal into simpler sinusoidal components, revealing the frequency content of the original signal. The continuous Fourier Transform, which may be used for continuous signals, and the Discrete Fourier Transform (DFT), which may be used for discrete signals, are two main variants of the Fourier Transform. The DFT may be calculated using algorithms like the Fast Fourier Transform (FFT) for efficiency. In practical applications, the Fourier Transform is employed to analyze signals, filter out specific frequencies, compress data, and perform various operations in both time and frequency domains.

### BRIEF SUMMARY

According to aspects of the present application there is provided a hybrid analog-digital processor for performing Fourier Transforms, the hybrid analog-digital processor comprising a digital processor configured to decompose an input digital signal into one or more first intermediate digital signals sized for inputting to an analog accelerator, a digital-to-analog converter configured to convert the one or more first intermediate digital signals into one or more first intermediate analog signals, and the analog accelerator, wherein the analog accelerator is configured to perform matrix-vector multiplication on the one or more first intermediate analog signals to generate one or more second intermediate analog signals, wherein the hybrid analog-digital processor is configured to compute a Fourier Transform of the input digital signal using the one or more second intermediate analog signals.

In some embodiments, the analog accelerator comprises a photonic accelerator configured to perform the matrix-vector multiplication using light.

In some embodiments, the hybrid analog-digital processor further comprises an analog-to-digital converter and computing the Fourier Transform of the input digital signal using the one or more second intermediate analog signals comprises using the analog-to-digital converter to convert the one or more second intermediate analog signals into one or more second intermediate digital signals and composing the one or more second intermediate digital signals into the Fourier Transform of the input digital signal.

In some embodiments, performing the matrix-vector multiplication on the one or more first intermediate analog signals to generate the one or more second intermediate analog signals comprises multiplying the one or more first intermediate analog signals by a Fourier Transform matrix.

In some embodiments, the Fourier Transform matrix comprises real and imaginary components and composing the one or more second intermediate digital signals into the Fourier Transform of the input digital signal comprises composing real and imaginary components of the one or more second intermediate digital signals.

In some embodiments, converting the one or more first intermediate digital signals into the one or more first intermediate analog signals comprises mapping the one or more first intermediate digital signals into real and imaginary components of the one or more first intermediate analog signals.

In some embodiments, decomposing the input digital signal into the one or more first intermediate digital signals sized for input into the analog accelerator comprises providing the one or more first intermediate digital signals with a length m and multiplying the one or more first intermediate analog signals by the Fourier Transform matrix comprises multiplying the one or more first intermediate analog signals by an m-dimensional Fourier Transform matrix.

In some embodiments, the digital processor is further configured to batch the one or more first intermediate digital signals into a 2D digital array converting the one or more first intermediate digital signals into one or more first intermediate analog signals comprises converting the 2D digital array into a 2D analog array and multiplying the one or more first intermediate analog signals by an m-dimensional Fourier Transform matrix comprises multiplying the 2D analog array by the m-dimensional Fourier Transform matrix.

In some embodiments, multiplying the one or more first intermediate analog signals by a Fourier Transform matrix comprises multiplying the one or more first intermediate analog signals by a submatrix of a full Fourier Transform matrix, the submatrix corresponding to a frequency bin of interest.

In some embodiments, decomposing the input digital signal into the one or more first intermediate digital signals sized for inputting to an analog accelerator comprises decomposing the input digital signal using a radix-2 Fourier Transform algorithm until the one or more first intermediate digital signals has a size equal to a size of the analog accelerator.

According to aspects of the present application there is provided a method for performing hybrid analog-digital Fourier Transforms, the method comprising digitally decomposing an input digital signal into one or more first intermediate digital signals sized for inputting to an analog accelerator, converting the one or more first intermediate digital signals into one or more first intermediate analog signals, using the analog accelerator to performing matrix-vector multiplication on the one or more first intermediate analog signals to generate one or more second intermediate analog signals, and computing a Fourier Transform of the input digital signal using the one or more second intermediate analog signals.

In some embodiments, the analog accelerator comprises a photonic accelerator and performing the matrix-vector multiplication comprises performing the matrix-vector multiplication using light.

In some embodiments, computing the Fourier Transform of the input digital signal using the one or more second intermediate analog signals comprises converting the one or more second intermediate analog signals into one or more second intermediate digital signals and composing the one or more second intermediate digital signals into the Fourier Transform of the input digital signal.

In some embodiments, performing the matrix-vector multiplication on the one or more first intermediate analog signals to generate the one or more second intermediate analog signals comprises multiplying the one or more first intermediate analog signals by a Fourier Transform matrix.

In some embodiments, the Fourier Transform matrix comprises real and imaginary components and composing the one or more second intermediate digital signals into the Fourier Transform of the input digital signal comprises composing real and imaginary components of the one or more second intermediate digital signals.

In some embodiments, converting the one or more first intermediate digital signals into the one or more first intermediate analog signals comprises mapping the one or more first intermediate digital signals into real and imaginary components of the one or more first intermediate analog signals.

In some embodiments, decomposing the input digital signal into the one or more first intermediate digital signals sized for input into the analog accelerator comprises providing the one or more first intermediate digital signals with a length m and multiplying the one or more first intermediate analog signals by the Fourier Transform matrix comprises multiplying the one or more first intermediate analog signals by an m-dimensional Fourier Transform matrix.

In some embodiments, the method further comprises batching the one or more first intermediate digital signals into a 2D digital array, converting the one or more first intermediate digital signals into one or more first intermediate analog signals comprises converting the 2D digital array into a 2D analog array, and

multiplying the one or more first intermediate analog signals by an m-dimensional Fourier Transform matrix comprises multiplying the 2D analog array by the m-dimensional Fourier Transform matrix.

In some embodiments, multiplying the one or more first intermediate analog signals by a Fourier Transform matrix comprises multiplying the one or more first intermediate analog signals by a submatrix of a full Fourier Transform matrix, the submatrix corresponding to a frequency bin of interest.

In some embodiments, decomposing the input digital signal into the one or more first intermediate digital signals sized for inputting to an analog accelerator comprises decomposing the input digital signal using a radix-2 Fourier Transform algorithm until the one or more first intermediate digital signals has a size equal to a size of the analog accelerator.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in the figures in which they appear.

FIG. 1A illustrates a representative matrix-vector multiplication, in accordance with some embodiments;

FIG. 1B is a block diagram illustrating a hybrid analog-digital processor configured to perform matrix-vector multiplication, in accordance with some embodiments;

FIG. 1C is a block diagram illustrating a portion of a photonic accelerator, in accordance with some embodiments;

FIG. 2 illustrates another representative matrix-vector multiplication, in accordance with some embodiments;

FIG. 3 illustrates yet another representative matrix-vector multiplication, in accordance with some embodiments;

FIGS. 4A-4B show a diagram illustrating steps of hybrid analog algorithm, in accordance with some embodiments;

FIG. 5 is a plot illustrating a comparison between a hybrid analog algorithm and a conventional algorithm, in accordance with some embodiments;

FIG. 6 is a plot illustrating accuracy of a hybrid analog algorithm, in accordance with some embodiments;

FIG. 7 is a plot illustrating accuracy of a hybrid analog algorithm, in accordance with some embodiments; and

FIG. 8 shows an exemplary process flow of a method of performing a hybrid analog-algorithm, in accordance with some embodiments.

### DETAILED DESCRIPTION

### I. Overview

Hybrid analog-digital processors and related methods are described. A hybrid analog-digital processor or related method may carry out an algorithm for efficiently performing a Fourier Transform with lower power consumption and higher speed compared with fully-digital processors. A hybrid analog-digital processor or related method may use a digital processor to perform some portions of a Fourier Transform, such as sizing signals for input into an analog accelerator (such as a photonic accelerator). The analog accelerator may be configured to perform some portions of the Fourier Transform by performing matrix-vector multiplication on the sized signals using light. Further efficiency may be provided by in some environments by batching signals that are input into the analog accelerator into 2D arrays, or by performing matrix-vector multiplication using a submatrix of a full Fourier Transform matrix.

As described herein, references to Fourier Transforms may be understood to refer to Fast Fourier Transforms (FFTs), Discrete Fourier Transforms (DFTs), and other calculations of Fourier components. The outputs of the FFT and DFT may be substantially similar or identical. In the present application, where a particular transform technique is relevant, then either FFT or DFT is generally explicitly stated.

According to aspects of the present application, there is provided a hybrid analog-digital processor configured to efficiently calculate Fourier Transforms. In addition to a digital processor and an analog accelerator (which may comprise a photonic accelerator configured to perform calculations using light), the hybrid processor may comprise a digital-to-analog converter (ADC) and an analog-to-digital converter (ADC) configured to provide communication between the digital processor and the analog accelerator.

The inventors have recognized and appreciated that analog (e.g., photonic) accelerators may be particularly efficient in performing certain types of calculations when compared with conventional fully-digital processors. For example, photonic accelerators may provide far more efficient computation of matrix operations, such as matrix-vector multiplication and other matrix multiplication. The photonic accelerations may provide increased efficiency with respect to power consumption and speed, among other improvements.

The inventors have also recognized and appreciated Fourier Transforms may be effected using matrix operations, such as matrix-vector multiplication. As such, the inventors have further recognized and appreciated that photonic accelerators may be used to provide improved efficiency Fourier Transforms.

According to aspects of the present application, these improved Fourier Transforms may be carried out using a hybrid processor by performing, with a photonic accelerator, those portions of the Fourier Transforms that are able to be computed using matrix operations, while performing, with a digital processor, operations for pre-processing input signals into a format suitable for use by the photonic accelerator and post-processing the outputs of the photonic accelerator in order to obtain the final Fourier Transform. For example, the digital processor may size an input signal of which a Fourier Transform is desired, into a signal length matching a dimension of the photonic accelerator.

### II. Hybrid Analog-Digital Processors

The hybrid analog-digital processors and related methods described herein may provide improved Fourier Transforms in a variety of computing environments. The inventors have recognized and appreciated that conventional computing systems are not sufficiently fast to keep up with the ever increasing demand for data throughput in modern applications. Conventional electronic processors face severe speed and efficiency limitations primarily due to the inherent presence of parasitic capacitance in electrical interconnects. Every wire and transistor in the circuits of an electrical processor has a resistance, an inductance, and a capacitance that cause propagation delay and power dissipation in any electrical signal. For example, connecting multiple processor cores and/or connecting a processor core to a memory uses a conductive trace with a non-zero impedance. Large values of impedance limit the maximum rate at which data can be transferred through the trace with a negligible bit error rate. Most conventional processors cannot support clock frequencies in excess of 2-3 GHz.

In applications where time delay is crucial, such as high frequency stock trading, even a delay of a few hundredths of a second can make an algorithm unfeasible for use. For processing that requires billions of operations by billions of transistors, these delays add up to a significant loss of time. In addition to electrical circuits' inefficiencies in speed, the heat generated by the dissipation of energy caused by the impedance of the circuits is also a barrier in developing electrical processors.

For example, speed and efficiency of computing systems may be of particular interest with respect to deep learning, machine learning, latent-variable models, neural networks, and other matrix-based differentiable programs. These programs may be used to solve a variety of problems, including natural language processing and object recognition in images. Solving these problems with deep neural networks typically uses long processing times to perform the computation. The conventional approach to speed up deep learning algorithms has been to develop specialized hardware architectures. This is because conventional computer processors, e.g., central processing units (CPUs), which are composed of circuits including hundreds of millions of transistors to implement logical gates on bits of information represented by electrical signals, are designed for general purpose computing and are therefore not optimized for the particular patterns of data movement and computation used by the algorithms that are used in deep learning and other matrix-based differentiable programs. One conventional example of specialized hardware for use in deep learning are graphics processing units (GPUs) having a highly parallel architecture that makes them more efficient than CPUs for performing image processing and graphical manipulations. After their development for graphics processing, GPUs were found to be more efficient than CPUs for other parallelizable algorithms, such as those used in neural networks and deep learning. This realization, and the increasing popularity of artificial intelligence and deep learning, led to further research into new electronic circuit architectures that could further enhance the speed of these computations.

Deep learning using neural networks conventionally uses two stages: a training stage and an evaluation stage (sometimes referred to as “inference”). Before a deep learning algorithm can be meaningfully executed on a processor, e.g., to classify an image or speech sample, during the evaluation stage, the neural network must first be trained. The training stage can be time consuming and uses intensive computation.

Aspects of the present application relate to analog accelerators configured to execute neural networks. Accelerators are microprocessors that are capable of accelerating certain types of workloads. Typically, workloads that can be accelerated are offloaded to high-performance accelerators, which are much more efficient at performing workloads such as artificial intelligence, machine vision, and deep learning. Accelerators are specific purpose processors and are often programmed to work in conjunction with general purpose processors to perform a task. Analog accelerators are accelerators that perform computations in the analog domain. As such, analog accelerators typically involve digital-to-analog conversion and analog-to-digital conversion, which allow an analog accelerator to communicate with digital hardware.

Photonic accelerators are a particular class of analog accelerators in which computations are performed in the optical domain (using light). The inventors have recognized and appreciated that using optical signals (instead of, or in combination with, electrical signals) overcomes some of the problems with electronic computing. Optical signals travel at the speed of light. Thus, the latency of optical signals is far less of a limitation than electrical propagation delay. Additionally, virtually no power is dissipated by increasing the distance traveled by the light signals, opening up new topologies and processor layouts that would not be feasible using electrical signals. Thus, photonic processors offer far better speed and efficiency performance than conventional electronic processors.

Some embodiments relate to photonic accelerators designed to run machine learning algorithms or other types of data-intensive computations. Certain machine learning algorithms (e.g., support vector machines, artificial neural networks and probabilistic graphical model learning) rely heavily on linear transformations on multi-dimensional arrays/tensors. The simplest linear transformation is a matrix-vector multiplication, which using conventional algorithms has a complexity on the order of O(N²), where N is the dimensionality of a square matrix being multiplied by a vector of the same dimension. General matrix-matrix (GEMM) operations are ubiquitous in software algorithms, including those for graphics processing, artificial intelligence, neural networks and deep learning.

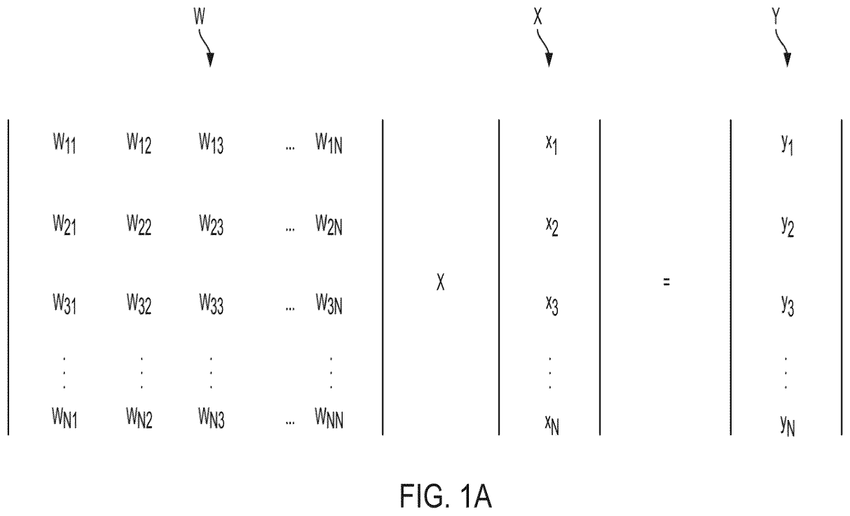

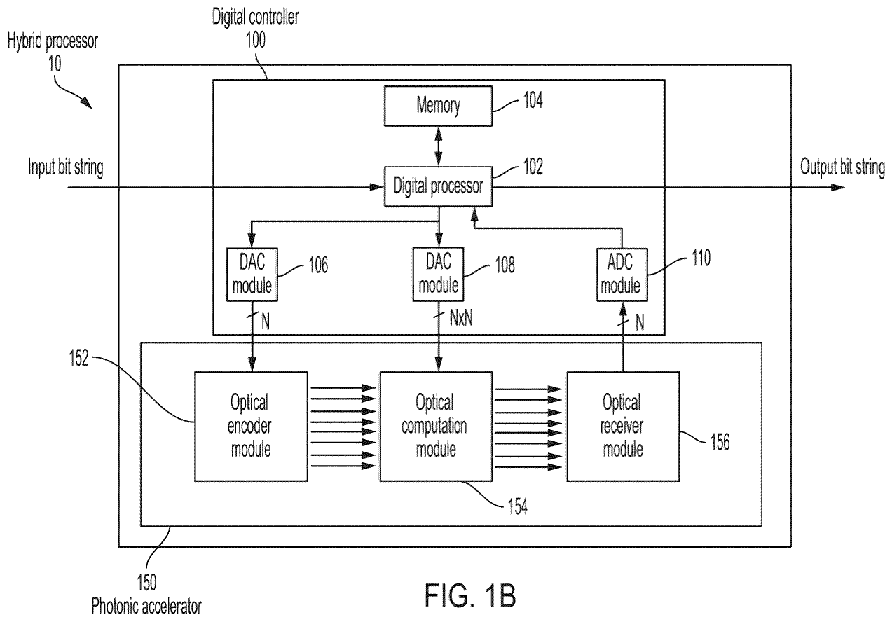

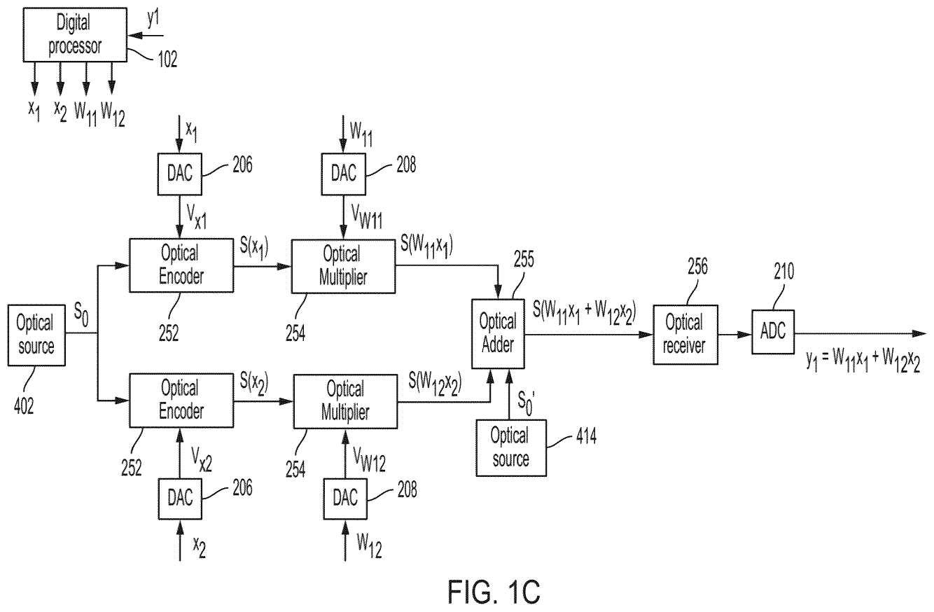

FIG. 1A is a representation of a matrix-vector multiplication, in accordance with some embodiments. Matrix-vector multiplication is an example of GEMM. Matrix W is referred to herein as “weight matrix,” “input matrix” or simply “matrix,” and the individual elements of matrix W are referred to herein as “weights,” “matrix values” or “matrix parameters.” Vector X is referred to herein as “input vector,” and the individual elements of vector X are referred to as “input values,” or simply “inputs.” Vector Y is referred to herein as “output vector,” and the individual elements of vector Y are referred to as “output values,” or simply “outputs.” In this example, W is an N×N matrix, though embodiments of the present application are not limited to square matrices or to any specific dimension. In the context of artificial neural networks, matrix W can be a weight matrix, or a block of submatrix of the weight tensor, or an activation (batched) matrix, or a block of submatrix of the (batched) activation tensor, among several possible examples. Similarly, the input vector X can be a vector of the weight tensor or a vector of the activation tensor, for example.

The matrix-vector multiplication of FIG. 1A can be decomposed in terms of scalar multiplications and scalar additions. For example, an output value yᵢ (where i=1, 2 . . . N) can be computed as a linear combination of the input values x₁, x₂ . . . X_{N}. Obtaining yᵢ involves performing scalar multiplications (e.g., Wᵢ₁ times X₁, and Wᵢ₂ times x₂) and scalar additions (e.g., Wᵢ₁x₁ plus Wᵢ₂x₂). In some embodiments, scalar multiplications, scalar additions, or both, may be performed in the optical domain, as discussed in detail further below.

FIG. 1B illustrates an electronic-photonic processor 10 implemented using photonic circuits, in accordance with some embodiments. Processor 10 may be configured to perform matrix multiplications (e.g., matrix-vector multiplications or matrix-matrix multiplications). Processor 10 includes a digital controller 100 and a photonic accelerator 150. Digital controller 100 operates in the digital domain and photonic accelerator 150 operates in the analog photonic domain.

Digital controller 100 includes a digital processor 102 and a memory 104. Photonic accelerator 150 includes an optical encoder module 152, an optical computation module 154 and an optical receiver module 156. Digital-to-analog (DAC) modules 106 and 108 convert digital data to analog signals. Analog-to-digital (ADC) module 110 converts analog signals to digital values. Thus, the DAC/ADC modules provide an interface between the digital domain and the analog domain. In this example, DAC module 106 produces N analog signals (one for each entry of an input vector), DAC module 108 produces N×N analog signals (one for each entry of a matrix), and ADC module 110 receives N analog signals (one for each entry of an output vector). Although matrix W is square in this example, it may be rectangular in some embodiments, such that the size of the output vector differs from the size of the input vector.

Processor 10 receives, as an input from an external processor (e.g., a CPU), an input vector represented by a group of input bit strings and produces an output vector represented by a group of output bit strings. For example, if the input vector is an N-dimensional vector, the input vector may be represented by N separate bit strings, each bit string representing a respective component of the vector. The input bit string may be received as an electrical signal from the external processor and the output bit string may be transmitted as an electrical signal to the external processor. In some embodiments, digital processor 102 does not necessarily output an output bit string after every process iteration. Instead, the digital processor 102 may use one or more output bit strings to determine a new input bit stream to feed through the components of the processor 10. In some embodiments, the output bit string itself may be used as the input bit string for a subsequent iteration of the process implemented by the processor 10. In other embodiments, multiple output bit streams are combined in various ways to determine a subsequent input bit string. For example, one or more output bit strings may be summed together as part of the determination of the subsequent input bit string.

DAC module 106 is configured to convert digital data into analog signals. The optical encoder module 152 is configured to convert the analog signals into optically encoded information to be processed by the optical computation module 154. The information may be encoded in the amplitude, phase and/or frequency of an optical pulse. Accordingly, optical encoder module 152 may include optical amplitude modulators, optical phase modulators and/or optical frequency modulators. In some embodiments, the optical signal represents the value and sign of the associated bit string as an amplitude and a phase of an optical pulse. In some embodiments, the phase may be limited to a binary choice of either a zero phase shift or a π phase shift, representing a positive and negative value, respectively. Embodiments are not limited to real input vector values. Complex vector components may be represented by, for example, using more than two phase values when encoding the optical signal.

The optical encoder module 152 outputs N separate optical pulses that are transmitted to the optical computation module 154. Each output of the optical encoder module 152 is coupled one-to-one to an input of the optical computation module 154. In some embodiments, the optical encoder module 152 may be disposed on the same substrate as the optical computation module 154 (e.g., the optical encoder module 152 and the optical computation module 154 are on the same chip). In such embodiments, the optical signals may be transmitted from the optical encoder module 152 to the optical computation module 154 in waveguides, such as silicon photonic waveguides.

The optical computation module 154 performs the multiplication of an input vector X by a matrix W. In some embodiments, optical computation module 154 includes multiple optical multipliers each configured to perform a scalar multiplication between an entry of the input vector and an entry of matrix W in the optical domain. Optionally, optical computation module 154 may further include optical adders for adding the results of the scalar multiplications to one another in the optical domain. Alternatively, the additions may be performed electrically. For example, optical receiver module 156 may produce a voltage resulting from the integration (over time) of a photocurrent received from a photodetector.

The optical computation module 154 outputs N separate optical pulses that are transmitted to the optical receiver module 156. Each output of the optical computation module 154 is coupled one-to-one to an input of the optical receiver module 156. In some embodiments, the optical computation module 154 may be disposed on the same substrate as the optical receiver module 156 (e.g., the optical computation module 154 and the optical receiver module 156 are on the same chip). In such embodiments, the optical signals may be transmitted from the optical computation module 154 to the optical receiver module 156 in silicon photonic waveguides. In other embodiments, the optical computation module 154 may be disposed on a separate substrate from the optical receiver module 156. In such embodiments, the optical signals may be transmitted from the photonic processor 103 to the optical receiver module 156 using optical fibers.

The optical receiver module 156 receives the N optical pulses from the optical computation module 154. Each of the optical pulses is then converted to an electrical analog signal. In some embodiments, the intensity and phase of each of the optical pulses is detected by optical detectors within the optical receiver module. The electrical signals representing those measured values are then converted into the digital domain using ADC module 110, and provided back to the digital processor 102.

The digital processor 102 controls the optical encoder module 152, the optical computation module 154 and the optical receiver module 156. The memory 104 may be used to store input and output bit strings and measurement results from the optical receiver module 156. The memory 104 also stores executable instructions that, when executed by the digital processor 102, control the optical encoder module 152, optical computation module 154 and optical receiver module 156. The memory 104 may also include executable instructions that cause the digital processor 102 to determine a new input vector to send to the optical encoder based on a collection of one or more output vectors determined by the measurement performed by the optical receiver module 156. In this way, the digital processor 102 can control an iterative process by which an input vector is multiplied by multiple matrices by adjusting the settings of the optical computation module 154 and feeding detection information from the optical receiver module 156 back to the optical encoder module 152. Thus, the output vector transmitted by the processor 10 to the external processor may be the result of multiple matrix-matrix multiplications, not simply a single matrix-matrix multiplication.

FIG. 1C illustrates a portion of photonic accelerator 150 in additional detail, in accordance with some embodiments. More specifically, FIG. 1C illustrates the circuitry for computing y₁, the first entry of output vector Y. For simplicity, in this example, the input vector has only two entries, x₁ and x₂. However, the input vector may have any suitable size.

DAC module 106 includes DACs 206, DAC module 108 includes DACs 208, and ADC module 110 includes ADC 210. DACs 206 produce electrical analog signals (e.g., voltages or currents) based on the value that they receive. For example, voltage V_{X1} represents value x₁, voltage V_{X2} represents value x₂, voltage V_{W11} represents value W₁₁, and voltage V_{W12} represents value W₁₂. Optical encoder module 152 includes optical encoders 252, optical computation module 154 includes optical multipliers 154 and optical adder 255, and optical receiver module 156 includes optical receiver 256.

Optical source 402 produces light So. Optical source 402 may be implemented in any suitable way. For example, optical source 402 may include a laser, such as an edge-emitting laser of a vertical cavity surface emitting laser (VCSEL), examples of which are described in detail further below. In some embodiments, optical source 402 may be configured to produce multiple wavelengths of light, which enables optical processing leveraging wavelength division multiplexing (WDM), as described in detail further below. For example, optical source 402 may include multiple laser cavities, where each cavity is specifically sized to produce a different wavelength.

The optical encoders 252 encode the input vector into a plurality of optical signals. For example, one optical encoder 252 encodes input value x₁ into optical signal S(x₁) and another optical encoder 252 encodes input value x₂ into optical signal S(x₂). Input values x₁ and x₂, which are provided by digital processor 102, are digital signed real numbers (e.g., with a floating point or fixed point digital representation). The optical encoders modulate light S₀ based on the respective input voltage. For example, optical encoder 404 modulates amplitude, phase and/or frequency of the light to produce optical signal S(x₁) and optical encoder 406 modulates the amplitude, phase and/or frequency of the light to produce optical signal S(x₂). The optical encoders may be implemented using any suitable optical modulator, including for example optical intensity modulators. Examples of such modulators include Mach-Zehnder modulators (MZM), Franz-Keldysh modulators (FKM), resonant modulators (e.g., ring-based or disc-based), nano-electro-electro-mechanical-system (NOEMS) modulators, etc.

The optical multipliers are designed to produce signals indicative of a product between an input value and a matrix value. For example, one optical multiplier 254 produces a signal S(W₁₁x₁) that is indicative of the product between input value x₁ and matrix value A₁₁ and another optical multiplier 254 produces a signal S(W₁₂x₂) that is indicative of the product between input value x₂ and matrix value W₁₂. Examples of optical multipliers include Mach-Zehnder modulators (MZM), Franz-Keldysh modulators (FKM), resonant modulators (e.g., ring-based or disc-based), nano-electro-electro-mechanical-system (NOEMS) modulators, etc. In one example, an optical multiplier may be implemented using a modulatable detector. Modulatable detectors are photodetectors having a characteristic that can be modulated using an input voltage. For example, a modulatable detector may be a photodetector with a responsivity that can be modulated using an input voltage. In this example, the input voltage (e.g., V_{W11}) sets the responsivity of the photodetector. The result is that the output of a modulatable detector depends not only on the amplitude of the input optical signal but also on the input voltage. If the modulatable detector is operated in its linear region, the output of a modulatable detector depends on the product of the amplitude of the input optical signal and the input voltage (thereby achieving the desired multiplication function).

Optical adder 412 receives electronic analog signals S(W₁₁x₁) and S(W₁₂x₂) and light S₀′ (generated by optical source 414), and produces an optical signal S(W₁₁x₁+W₁₂x₂) that is indicative of the sum of W₁₁x₁ with W₁₂x₂.

Optical receiver 256 generates an electronic digital signal indicative of the sum W₁₁x₁+W₁₂x₂ based on the optical signal S(W₁₁x₁+W₁₂x₂). In some embodiments, optical receiver 256 includes a coherent detector and a trans-impedance amplifier. The coherent detector produces an output that is indicative of the phase difference between the waveguides of an interferometer. Because the phase difference is a function of the sum W₁₁x₁+W₁₂x₂, the output of the coherent detector is also indicative of that sum. The ADC converts the output of the coherent receiver to output value y₁₌W₁₁x₁+W₁₂x₂. Output value y₁ may be provided as input back to digital processor 102, which may use the output value for further processing.

### III. Fourier Transforms

According to some embodiments of the present application, a hybrid processor, such as hybrid processor 10, may be used to perform various Fourier Transforms or associated algorithms.

The inventors have recognized and appreciated that a hybrid analog-digital processors, and related methods, may be used with various algorithms described herein. The hybrid analog-digital processors and related methods utilizing the algorithms provided herein may be used for computing a DFT by combining at least one digital processor performing digital signal processing, with at least one photonic accelerator (such as an analog, linear, photonic processor or photocore) performing matrix-vector products (MVPs) in order to more efficiently compute DFTs. In various embodiments, computation may be made more efficient by replacing stages of an FFT and instead performing computation by a photonic accelerator. When deployed in different operating environments where such a photonic accelerator has various performance and energy characteristics, using the algorithms described herein may provide lower run time and energy usage than a conventional, fully-digital FFT.

One such algorithm is a Hybrid-Analog-FFT (HA-FFT) algorithm, described in greater detail below. Another such algorithm provided herein is an Efficient-Hybrid-Analog-FFT algorithm (Efficient-HA-FFT), which may be used to improve efficiency by batch processing intermediate stage inputs. A further such algorithm described herein is an Adjustable-High-Resolution-Analog DFT (AHRA-DFT), which may be used to compute frequency components of a signal using a photonic accelerator.

According to some embodiments, an Hybrid-Analog-FFT or an Efficient Hybrid-Analog-FFT algorithm combines aspects of FFT techniques with analog matrix-vector products to compute a full DFT of a signal. According to some embodiments, an Adjustable-High-Resolution-Analog DFT algorithm may be used to focus on a frequency range and compute, depending on the length of the signal, arbitrarily fine frequency components. Depending on performance and energy characteristics of the photonic accelerator, the Hybrid-Analog-FFT, Efficient Hybrid-Analog-FFT, and Adjustable-High-Resolution-Analog DFT used with hybrid processors may provide faster and lower energy consumption compared with conventional fully-digital processors.

Aspects of the present application relate to hybrid processors and related methods employing algorithms described herein may be employed with applications using a DFT for signal processing. In some embodiments, such hybrid processors and related methods may be used in applications for filtering signals by using the Fourier Convolution Theorem, finding sparse representations of signals by selecting the largest frequency components, bandpass filtering signals by selecting components within a frequency range, and other applications using Fourier Transforms. According to aspects of the present application, these hybrid processors and related methods may be broadly applied where conventional digital signal processing algorithms are used to compute a DFT or FFT of a signal in software and/or hardware. Indeed, mapping signals to a Fourier domain representation is ubiquitous in digital signal processing. According to aspects of the disclosure, the algorithms described herein may additionally be applied to radar, communications, acoustics, sonar, compression routines, scientific, and other solvers that use the FFT in order to efficiently implement filtering, convolution, resampling, and a wide range of other mathematical operations.

In various embodiments, the Fourier Transform algorithms described herein may be performed by hybrid analog-digital processors to compute machine learning software algorithms more efficiently, and have applications in graphics processing, artificial intelligence, neural networks and deep learning, among other applications. Many machine learning software algorithms employ the FFT (and in some situations, other Fourier Transforms), for example, in order to process data sets in the frequency domain. In some embodiments, Fourier Transforms may be applied to machine learning software algorithms related to Neural Networks, such as Convolutional Neural Networks (CNNs). Some implementations of Convolutional Neural Networks may be used to as a deep learning architecture for image analysis, among other analyses. Convolutional Neural Networks may employ Fourier Transforms in order to provide a convolutional filter that may detecting particular frequency components in images. Using a Fourier Transform in this manner may improve the performance of Convolutional Neural Networks in image classification and object recognition tasks. In some embodiments, Fourier Transforms may be applied to machine learning software algorithms related to Natural Language Processing (NLP). Some implementations of Natural Language Processing provide representations of sequences of words and treat the representations as discrete signals. The Natural Language Processing may then apply a Fourier Transform to the representations in order to better analyze the textual data in the frequency domain, for applications in text classification, sentiment analysis, and topic modeling. In some embodiments, Fourier Transforms may be applied to machine learning software algorithms related to Time Series Analysis. Time Series Analysis may be applied to environments of finance, healthcare, weather forecasting, and other environments where time series data is abundant. Time Series Analysis algorithms may employ a Fourier Transform in order to extract features of relevance from time series data sets by enabling analysis of the frequency components of the time series data, which may provide efficient processing in applications such as anomaly detection, trend analysis, and forecasting, and other tasks. According to various embodiments, Fourier Transforms may further be deployed in any other machine learning software algorithms where processing data sets in the frequency domain is of interest or provides efficient performance.

According to some embodiments, taking an FFT of a signal of length N may have on the order O(N log₂(N)) operations whereas a DFT of the same signal may have on the order O(N²) operations. According to aspects of the disclosure, even though an FFT may be computationally more efficient than a mathematically similar or equivalent DFT calculation, a photonic accelerators may be used in order for the computation to be performed even more efficiently. Photonic accelerators are well-suited for algorithms that employ general matrix-matrix (GEMM) multiplications. One of the simplest GEMM operations is an matrix-vector product. A matrix-vector product using conventional digital computers may take O(N²) multiply-accumulate (MAC) operations where N is the length of the vector. According to aspects of the disclosure, a photonic accelerator can perform the matrix-vector product in a highly parallel manner, thereby allow a similar or same operation to be completed in 1 clock cycle. Accordingly, a Hybrid-Analog-FFT that uses photonic accelerators for GEMM operations may be used to provide a more efficient system than a conventional fully-digital FFT implementation.

To perform a DFT of a given signal x, of N real numbers [x₀, . . . , X_{N-1}], the computation may be performed according to Equation 1.

$${c}_{k} = \frac{1}{N} {\sum }_{j = 0}^{N - 1} {x}_{j} {e}^{- i j k 2 π / N} , k = 0 , … , N - 1 \qquad ( 1 )$$

Following Equation 1, the mapping of xⱼ, j=0, . . . , N−1, into

$${c}_{k} = \frac{1}{N} {\sum }_{j = 0}^{N - 1} {x}_{j} {e}^{- i j k 2 π / N} ,$$

k=0, . . . , N−1, may provide the DFT of the signal x.

A parameter ω may be defined according to Equation 2.

$${ω}_{N} = {e}^{- 2 π i / N} \qquad ( 2 )$$

Furthermore, the DFT may then be provided in terms of ω according to Equation 3.

$${c}_{k} = \frac{1}{N} {Σ}_{j = 0}^{N - 1} {x}_{j} {e}^{- ijk 2 π / N} = \frac{1}{N} {Σ}_{j = 0}^{N - 1} {x}_{j} {ω}_{N}^{j k} \qquad ( 3 )$$

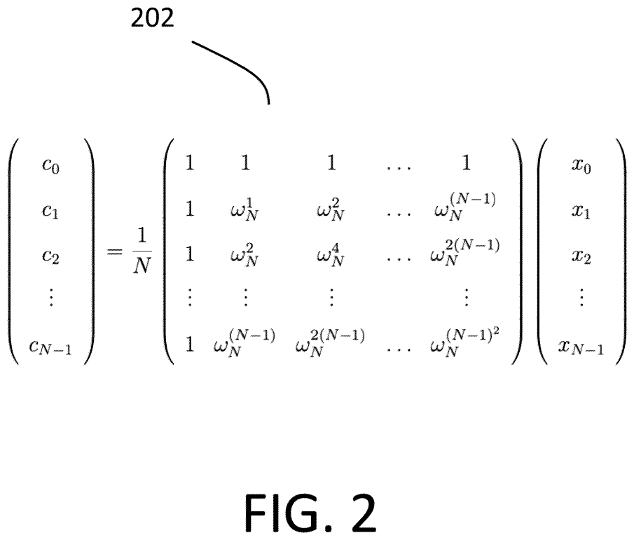

Using Equation 3, the DFT may be computed as a matrix-vector product using Equation 202, as illustrated in FIG. 2.

Furthermore, the FFT may be used to compute an output of Equation 202 using a radix-2 algorithm more efficiently. The radix-2 algorithm is an FFT algorithm that may be recursively carried out by the hybrid processor in order to decompose input signals for inputting into the photonic accelerator of the hybrid processor. For example, the radix-2 algorithm may be used to decompose an input signal into two interleaved signals each having a length that is half of the input signal. The radix-2 algorithm may further be employed to the two interleaved signals to obtain four signals, and so on. By using the radix-2 algorithm, a DFT may be performed separately on the different interleaved signals, and the results may then be combined to give the DFT of the input signal. By performing separate DFTs on each of the different interleaved signals, the overall runtime of the Fourier Transform may be greatly reduced. Such a radix-2 algorithm may be made even further efficient by dividing its steps among the digital processor and photonic accelerator of a hybrid processor.

According to some embodiments, the radix-2 FFT applied to a signal of length N, where N is a power of 2, comprises a recursive algorithm given by Algorithm 1 below.

Algorithm 1 Cooley-Tukey, Radix-2 Algorithm
The algorithm is called recursively until the length of the signal is 1.

```
  X + FFT(x)
Require: len(x) = 2^{l} for some l ∈ [0, 1, 2, . . . ]
  N = len(x)
  if N = 1 then
    X ← x
  else
    Eₖ = FFT((x₀, x₂, . . . , x_{N-2})) # even samples of x
    Oₖ = FFT((x₁, x₃, . . . , x_{N-1})) # odd samples of x
    for k = 0, . . . , N/2 − 1
      p ← Eₖ
      q ← ω_{N}^{k}Oₖ
      Xₖ ← p + q
      X_{k+N/2} ← p − q
  end if
```

According to aspects of the disclosure, a hybrid processor performing a Hybrid-Analog-FFT, Efficient-Hybrid-Analog-FFT, or Adjustable-High-Resolution-Analog DFT algorithms may comprise a digital processor, a digital-to-analog converter (DAC), a photonic accelerator configured to compute matrix-vector products, and an analog-to-digital converter (ADC).

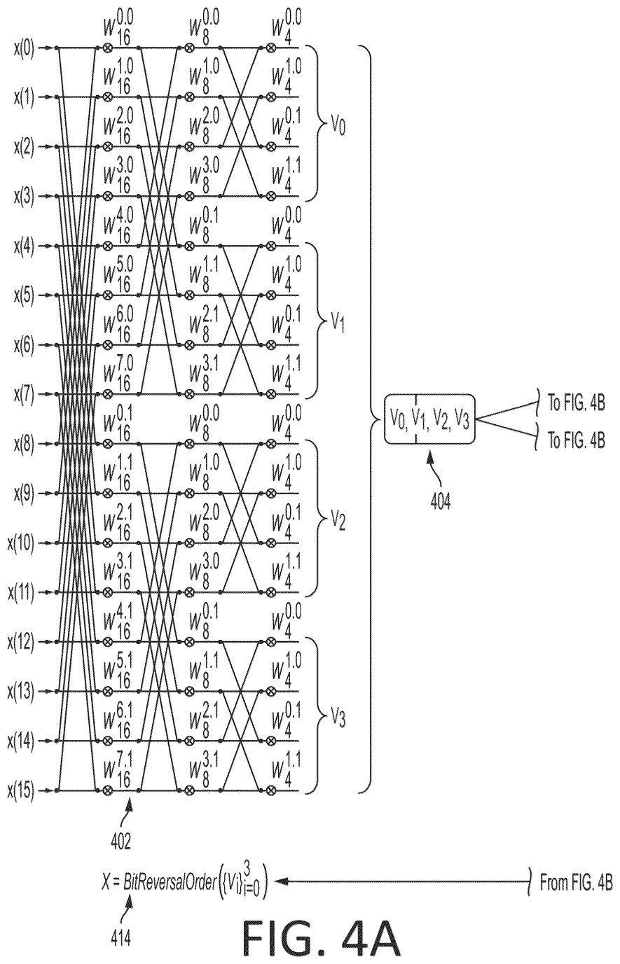

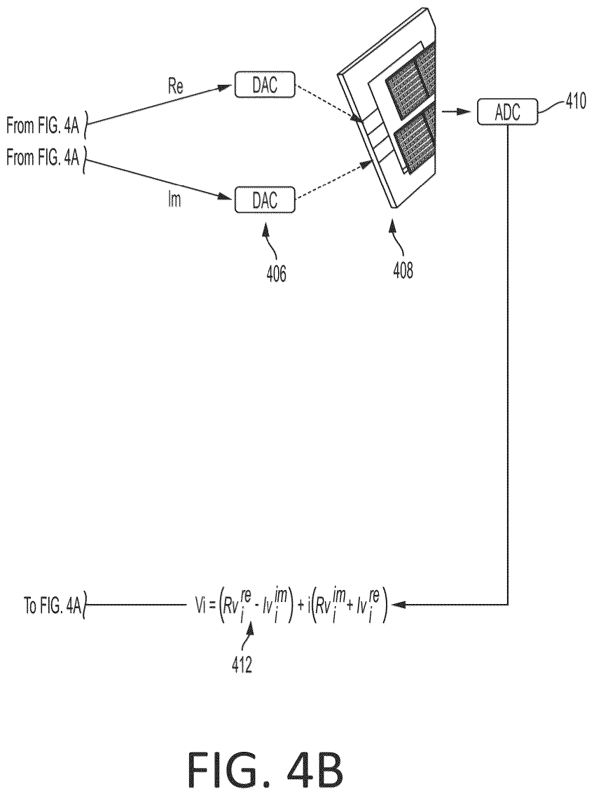

Described first is a Hybrid-Analog-FFT algorithm. According to Hybrid-Analog-FFT algorithm, first, a hybrid processor uses a digital processor to perform the first stages of an FFT algorithm to digitally decompose a signal of length n into k subsignals of length m where m is the dimension of the input vector to a photonic accelerator. Second the hybrid processor uses a photonic accelerator to compute an m-dimensional DFT on each of the k subsignals. Third, the hybrid processor combines the DFT processed subsignals into a single signal using bit-reversed output ordering that is equal to the DFT of the original signal. Furthermore, where signals are transferred from the digital processor to the photonic accelerator, the hybrid processor may use a DAC to convert digital signals from the digital processor into analog signals for the photonic accelerator. Moreover, where signals are transferred from the photonic accelerator to the digital processor, the hybrid processor may use an ADC to convert analog signal from the photonic accelerator into digital signals for the digital processor. An illustration of this procedure is described below with respect to FIGS. 4A-4B.

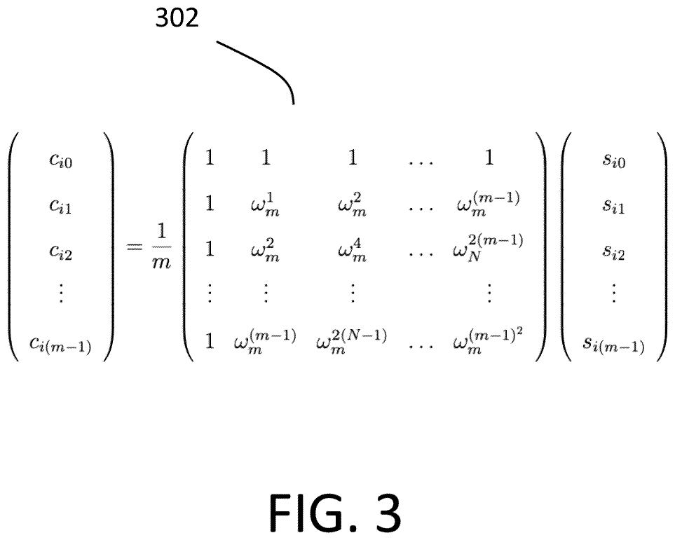

The k signals of the length m may be denoted as [s₀, S₁, . . . , Sₖ₋₁], and an m-dimensional DFT is applied as in Equation 302 illustrated in FIG. 3 for i=0, . . . , k−1.

According to some embodiments, the matrix and vector in Equation 302 may be complex-valued. The hybrid processor may compute this complex-matrix-vector product using 4 real-valued matrix-vector products according to Equation 4.

$$C = ( Re ( W ) Re ( s ) - Im ( W ) Im ( s ) ) + i ( Re ( W ) Im ( s ) + Im ( W ) Re ( s ) ) \qquad ( 4 )$$

As provided in Equation 4, Re( ) and Im( ) take the real and imaginary components, respectively.

One exemplary implantation of a Hybrid-Analog-FFT algorithm is provided and described in Algorithm 2 below.

Algorithm 2 Hybrid-Analog-FFT (HA-FFT)
The DFT using a partial FFT and Analog MVPs

```
  X ← FFT(x)
Require: len(x) = 2^{l} for some l ∈ [0, 1, 2, . . .]
  N = len(x)
  Load the real and imaginary components of the m-dimensional DFT matrix into
  photocore weights, [symbol]  and [symbol] , respectively.
  if N = m then
    Compute xᵣₑ = [symbol]     (x) and xᵢₘ = [symbol]     (x)
    Use a digital-to-analog converter to map xᵣₑ and xᵢₘ to an analog signals, xᵣₑ^{A}
    and xᵢₘ^{A}, respectively.
    Compute [symbol]   , [symbol]   , [symbol]   , [symbol]     using the photcores.
    Use an analog-to-digital converter to map each [symbol] , [symbol]    , [symbol]   , [symbol]
    to a digital signal, [symbol]   , [symbol]     , [symbol]      , [symbol]
    X ← ( [symbol]   − [symbol]     + i( [symbol]     + [symbol]   )
  else
    Eₖ = FFT(x₀, x₂, . . . , x_{N-2})) # even samples of x
    Oₖ = FFT((x₁, x₃, . . . , x_{N-1})) # odd samples of x
    $for k = 0 , … , \frac{N}{2} - 1$
      p ← Eₖ
      q ← ω_{N}^{k}Oₖ
      Xₖ ← p + q
      ${X}_{k + \frac{N}{2}} ← p - q$
  end if
```

According to aspects of the disclosure, there is further provided an Efficient-Hybrid-Analog-FFT which may be performed by a hybrid processor. One exemplary implementation of an Efficient-Hybrid-Analog-FFT is provided in Algorithm 3 below.

In some embodiments, the hybrid processor may use a radix-2 FFT algorithm to decompose the input signal, x, in stages. For example, where the input signal is of length N, a hybrid processor may use the first decomposition with the radix2Level( ) function below to decompose the signal into an even signal and an odd signal, both of length N/2. The radix2Level( ) function may be used by the hybrid processor in a recursive function, getRadix2Levels( ) to transform x into k, m-dimensional signals where N=k*m. For example, if an original signal has N=1024, then the hybrid processor may use getRadix2Levels( ) to decompose it into 8 signals of length 128 or 16 signals of length 64, and so on.

```
Algorithm 3 Efficient-Hybrid-Analog-FFT (Efficient-HA-FFT)
Efficiently computes the DFT using a partial FFT and Analog MVPs by batch processing
photocore input vectors.
  X ← Efficient-HA-FFT(x)
Require: len(x) = 2^{l} = N for some l ∈ [0, 1, 2, . . . ]
Require: photocore size is m, where m = 2^{p} for some p ∈ [0, 1, 2, . . . , l]
  1. Load the real and imaginary values of the m-dimensional DFT matrix onto the
  photocores.
  2. $Use getRadix 2 Levels ( x , m ) on the CPU to compute k = \frac{N}{m} subsignals ,$
  {s₀, . . . , sₖ₋₁}, of length m. For efficiency, batch these signals into a 2d-array.
  3. Use a digital-to-analog converter to map each sᵢ to an analog vector input, sᵢ^{A},
  for the photocore.
  4. For each sᵢ^{A}, compute the m-dimensional DFT, Sᵢ^{A}, in analog using the photo-
  core.
  5. Use an analog-to-digital converter to map each Sᵢ^{A} to a digital signal, Sᵢ.
  6. Use the CPU to combine the DFT processed subsignals, {S₀, . . . , Sₖ₋₁}, into a
  single signal, X, using bit-reversed output ordering as in getBitReversalOrder.
```

As merely one exemplary embodiment, a computeHybridFFT function is provided in the example code below showing how one implementation of an Efficient-Hybrid-Analog-FFT may be computed according to Algorithm 3. According to some embodiments, a hybrid processor may execute such a computeHybridFFT function.

```
import numpy as np
def radix2Level(signal):
  # returns the radix2 even/odd decomposition
  # for 1-level down the butterfly
  n = len(signal)
  first_inds = np.arange(n//2)
  w_n = np.exp(−2*np.pi*1j*first_inds/n)
  second_inds = np.arange(n//2, n)
  even_signal = signal[first_inds] + signal[second_inds]
  odd_signal = (signal[first_inds] − signal[second_inds])*w_n
  return even_signal, odd_signal
def getRadix2Levels(signal, min_length=128):
  # This function recursively call radix2Level until we have signals
  # that are of size min_length.
  if len(signal)==min_length:
    return signal
  else:
    even, odd = radix2Level(signal)
    return getRadix2Levels(even, min_length=min_length),
      getRadix2Levels(odd, min_length=min_length)
def getBitReversalOrder(sig_len):
  # This is the order in which the FFTs need to be combined.
  # make sure sig_len is a power of 2
  out = [0]
  a = int(np.log2(sig_len))
  b = sig_len/(2 ** np.arange(1,a+1))
  b = b.astype(‘int’)
  for bb in b:
    a = out + bb
    out = np.concatenate([out, a])
  return out
def computeHybridFFT(x, photocore_size=128):
  n = len(x)
  A = get_radix2_levels(x, min_length=photocore_size)
  D = dft(photocore_size)
  if type(A) == tuple:
    A = np.array(A)
    dft_input_vecs = A.reshape(np.prod(A.shape[:−1]), A.shape[−1]).T
    fft_vecs = D@dft_input_vecs
    fft_output_order = getBitReversalOrder(dft_input_vecs.shape[1])
    y_hybrid = np.empty((n,), dtype=dft_input_vecs.dtype)
    k = dft_input_vecs.shape[1]
    for idx, i in enumerate(fft_output_order):
      y_hybrid[idx::k] = fft_vecs[:,i]
  else:
    y_hybrid = D@A
  return y_hybrid
```

FIGS. 4A-4B show a diagram illustrating data flow according to an Efficient-Hybrid-Analog-FFT algorithm. FIGS. 4A-4B illustrate steps for computing an Efficient-Hybrid-Analog-FFT, according to some embodiments. At step 402 of FIGS. 4A-4B, an input signal, x, is passed through stages of an FFT algorithm until the intermediate vectors, vᵢ, are the correct input size for the photonic accelerator. This step may be performed in the digital domain by digital processor 102 (FIG. 1B). At step 404 of FIGS. 4A-4B, the vectors are concatenated into a 2D array for batch processing. This step may also be performed in the digital domain by digital processor 102. At step 406 of FIGS. 4A-4B, the real and imaginary components of the array are passed through DACs (e.g., DAC module 106 of FIG. 1B) to create inputs for the photonic accelerators. At step 408 of FIGS. 4A-4B, the photonic accelerators (e.g., photonic accelerator 150 of FIG. 1B), preloaded with the real and imaginary values of the DFT matrix, compute the matrix-vector product in the analog domain (e.g., in the photonic domain). At step 410 of FIGS. 4A-4B the matrix-vector product outputs are passed through an ADC (e.g., ADC 110 of FIG. 1B). At step 412 of FIGS. 4A-4B, the signals are combined to create Vᵢ, the DFT of each vᵢ vector. This step may also be performed in the digital domain by digital processor 102. At step 414 of FIGS. 4A-4B, the DFT vectors are concatenated in bit-reversal order giving the FFT of x. This step may also be performed in the digital domain by digital processor 102.

In applications according to some embodiments, only a subset of high-resolution, frequency components may be of interest. According to the Nyquist sampling theorem, the range of frequency components may be half of the sampling rate, Sᵣ, and the resolution of the frequency bins may also be a function of the number of times samples, N, collected. If the signal is collected for an arbitrary amount of time, then the resolution of the frequency bins may be provided according to Equation 5.

$$Δ f = \frac{{S}_{r}}{N} \qquad ( 5 )$$

In some applications, measuring the signal may only be of interest at m specific frequency bins. According to aspects of the present application, with limited frequencies of interest, there are provided computations that are even more efficiently than a conventional FFT approach. According to some conventional approaches, when only m frequency outputs are needed, a subset of the FFT computations may be taken. Such a computation may have on the order of O(m log₂(N)) operations.

According to the efficient algorithms described herein, the computation may be performed by building an m×N dimensional submatrix, S out of the rows of the N×N DFT matrix. Where {k₁Δƒ, . . . , kₘΔƒ} are the frequency bins of interest, then the {k₁, . . . , kₘ} rows of the DFT matrix may form the submatrix S. According to this approach, the response at the frequency bins of interest is provided by a matrix-vector product of the submatrix S with the signal according to Equation 6.

$${c}_{{k}_{p}} = \frac{1}{N} {Σ}_{j = 0}^{N - 1} {x}_{j} {e}^{- {ijk}_{p} 2 π / N} = \frac{1}{N} {Σ}_{j = 0}^{N - 1} {x}_{j} {ω}_{N}^{{jk}_{p}} \qquad ( 6 )$$

In some embodiments, S may be tiled into L=┌N/m┐ submatrices, Sₚ, p=0, . . . , L−1, of size m×m that may be partitioned across the columns of S. The j^{th} column of Sₚ may comprise the p*m+j column of S. Where N is not an integer multiple of m, then S_{L-1} may be zero padded with columns until it is an m×m matrix.

According to aspects of the disclosure, there is provided an Adjustable-High-Resolution-Analog DFT which may be performed by a hybrid processor (e.g., processor 10 of FIG. 1B). One exemplary implementation of an Adjustable-High-Resolution-Analog DFT is provided in Algorithm 4 below.

The Adjustable-High-Resolution-Analog DFT may be used by a hybrid processor where there are limited frequencies of interest, and may perform even more efficiently, by using the submatrix, S based on the frequency bins of interest, as described above.

```
Algorithm 4 Adaptive High-Resolution-Analog-FFT (AHRA-FFT)
Efficiently computes m frequency components of a signal, x, of length N.
Require: Signal x of length N and frequency bins {k₁, . . . . kₘ}.
  X ← AHRA-FFT(x, k₁, . . . , kₘ)
  1. Construct submatrices, Sₚ, p = 0, . . . , L − 1 as above where L = ┌N/m┐.
  2. Partition x into L signals, xₚ, p = 0, . . . L − 1 such that xₚ, is the p * m + i
  element of x. Zero-pad x_{L} if necessary.
  3. Use a digital-to-analog converter to map the real component, xₚ^{Re} = [symbol]   e(xₚ),
  and imaginary component, xp^{Im} = [symbol]  (xₚ), of each to analog vector inputs, xₚ^{Re,A},
  xₚ^{IM,A}, respectively.
  4. Use a digal-to-analog converter to map the real and imaginary components
  of the submatrices, [symbol] e(Sₚ) and [symbol] (Sₚ), to the photocores. These are Sₚ^{RE,A} and
  Sₚ^{Im,A}, respectively.
  5. For p = 0, . . . , L − 1 compute the MVPs below in analog.
      yₚ^{RR,A} = Sₚ^{Re,A}xₚ^{Re,A}
      yₚ^{II,A} = Sₚ^{IM,A}xₚ^{Im,A}
      yₚ^{RI,A} = Sₚ^{Re,A}xₚ^{Im,A}
      yₚ^{IR,A} = Sₚ^{Im,A}xₚ^{Re,A}
  6. Use an analog-to-digital converter to map each analog output back to a digital signal.
      yₚ^{RR} ← yₚ^{RR,A}
      yₚ^{II} ← yₚ^{II,A}
      yₚ^{RI} ← yₚ^{RI,A}
      yₚ^{IR} ← yₚ^{IR,A}
  7. Use the CPU to compute yₚ = (yₚ^{RR} − yₚ^{II}) + i(yₚ^{RI} + yₚ^{IR}).
  8.   $X = {\sum }_{p = 0}^{L - 1} {y}_{p}$
```

### IV. Results

According to some embodiments, the Hybrid-Analog-FFT, Efficient Hybrid-Analog-FFT, and Adjustable-High-Resolution-Analog DFT algorithms described herein may be used by a hybrid processor comprising a digital processor and a photonic accelerator to more efficiently perform Fourier Transforms and related computations. Provided below are results of a hybrid processor using the Hybrid-Analog-FFT, Efficient Hybrid-Analog-FFT, and Adjustable-High-Resolution-Analog DFT algorithms according to merely a few exemplary implementations.

For the exemplary results, a sinusoidal signal with a frequency of ƒ₀=30 Hz may be sampled at 180 Hz for 1,024 time samples. The signal may be provided according to Equation 7.

$$x ( t ) = sin ( 2 π {f}_{0} t ) \qquad ( 7 )$$

A photonic accelerator may be assumed to store a matrix of size 128×128 that is multiplied with a 128 dimensional input signal. Using an input signal that is 1,024-dimensional, the Hybrid-Analog-FFT algorithm may compute the first 3 FFT stages to produce 8=1,024/128 signals for the photonic accelerator.

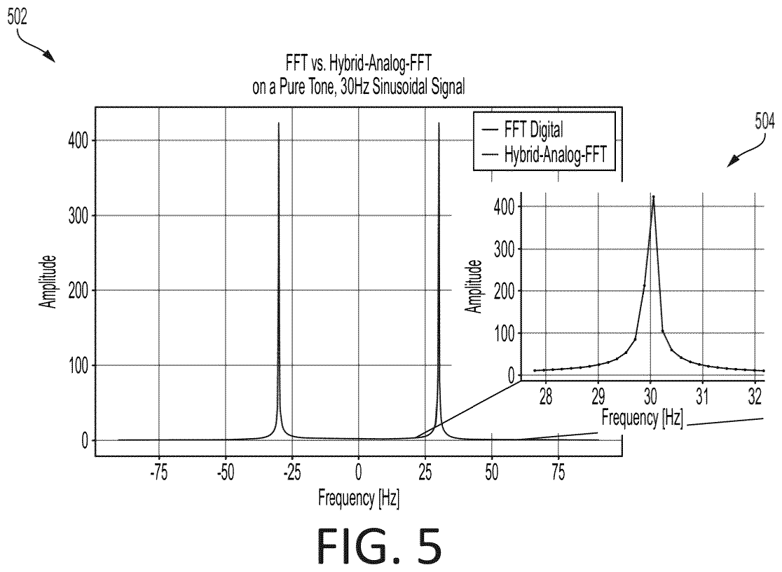

FIG. 5 shows plot 502 (with inset 504), which demonstrates that the Hybrid-Analog-FFT algorithm agrees with the DFT and FFT algorithms on a pure sinusoidal signal. Plot 502 shows an FFT versus the Hybrid-Analog-FFT algorithm on a pure tone of a 30 Hz sinusoidal signal, with a horizontal axis of frequency in Hz and a vertical axis of amplitude. As shown in plot 502 and inset 504 of FIG. 5, a solid curve is the magnitude of the FFT of a sinusoidal signal, and a dashed curve is the magnitude of the Hybrid-Analog-FFT of the same signal.

As shown by FIG. 5 without effects of quantization and analog noise, the Hybrid-Analog-FFT algorithm provides similar or same results as the conventional FFT algorithm.

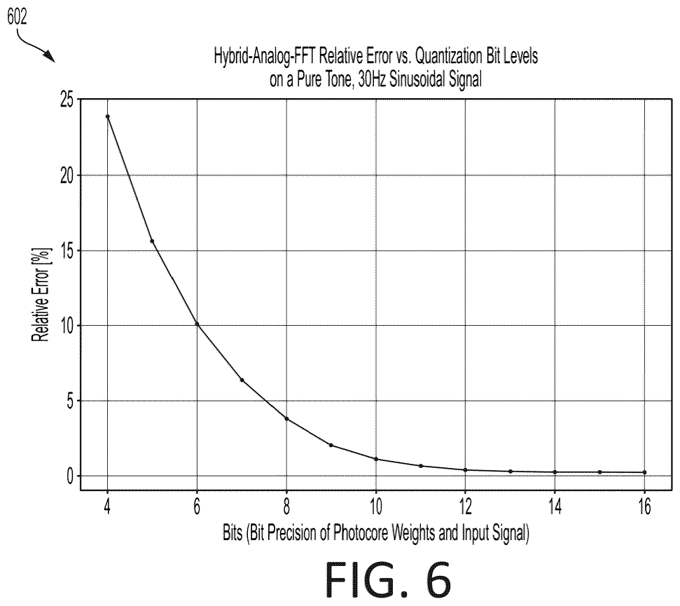

FIG. 6 shows plot 602, which demonstrates accuracy of the Hybrid-Analog-FFT algorithm as function of the bit-precision of the analog-to-digital and digital-to-analog converters. Plot 602 shows Hybrid-Analog-FFT algorithm relative error versus quantization bit levels on a pure tone of a 30 Hz sinusoidal signal, with a horizontal axis of bits in bit precision of photocore wights and input signal, and a vertical axis or relative error in percentage.

As shown in plot 602 of FIG. 6, relative error of the Hybrid-Analog-FFT algorithm applied to a sinusoidal signal may decrease as the bit-precision of the photonic accelerator weights and input signal increases.

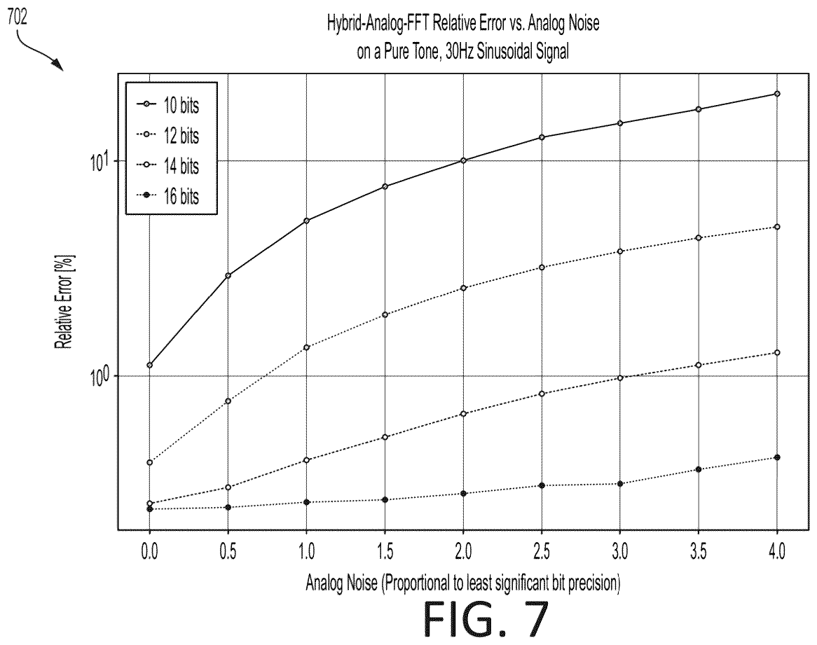

Plot 702 of FIG. 7 demonstrates how accuracy of the Hybrid-Analog-FFT algorithm may relate to noise of the photonic accelerator. The noise may affect the precision of the matrix-vector product. In some embodiments, precision may be improved by repeating the photonic accelerator matrix-vector product several times and averaging the results. Plot 702 shows Hybrid-Analog-FFT algorithm relative error versus analog noise on a pure tone of a 30 Hz sinusoidal signal, with a horizontal axis of analog noise proportional to least significant bit precision, and a vertical axis or relative error in percentage. As shown in plot 702 of FIG. 7, a solid curve is 10 bits, a second from the top curve is 12 bits, a second from the bottom curve is 14 bits, and a bottom curve is 16 bits.

As shown in plot 702 of FIG. 7, the relative error of the Hybrid-Analog-FFT algorithm applied to a sinusoidal signal may increase, in relation to the bit precision, as the analog noise of the photonic accelerator increases.

In certain applications, a hybrid processor may use less energy to perform the same computation as a conventional fully-digital processor. According to some embodiments, energy used to compute a Hybrid-Analog-FFT algorithm may depend on the size of the photonic accelerator, the size of the input signal, the amount of joules used to do a single matrix-vector product using the photonic accelerator, the amount of energy used to pass the data through a DAC and back through an ADC, and the amount of energy used to do a multiply and accumulate (MAC) operation on a digital processor (such as a CPU).

For example, the energy used to compute the FFT of a signal of length n scales with the number of operations used. If α is the amount of energy used to compute a single MAC, then the energy to compute the FFT using a conventional fully-digital processor is provided according to Equation 8.

$${E}_{F F T} ( n ) \approx α n {log}_{2} ( n ) \qquad ( 8 )$$

Setting aside the ADC, DAC energy usage and the energy used to transfer data to and from the photonic accelerator, then the energy used to compute the Hybrid-Analog-FFT of the same signal may be provided according to Equation 9.

$${E}_{HA - FFT} ( n ) \approx α n {log}_{2} ( \frac{n}{m} ) + β \frac{n}{m} \qquad ( 9 )$$

In Equation 9 m is the size of the photonic accelerator, 2≤m≤ n, and β is the energy used to perform a matrix-vector product on the photonic accelerator. The difference in energy usage is provided according to Equation 10.

$${E}_{F F T} ( n ) - {E}_{HA - FFT} ( n ) \approx α n {log}_{2} ( m ) - β \frac{n}{m} \qquad ( 10 )$$

Therefore, a Hybrid-Analog-FFT may become more energy efficient than a conventional fully-digital FFT when the inequality provided according to Equation 11 is satisfied.

$$β < α m {log}_{2} ( m ) \qquad ( 11 )$$

The inequality according to Equation 11 shows that where the energy used to do an m-dimensional matrix-vector product on the photonic accelerator is less than the energy used to compute an m-dimensional FFT, then the Hybrid-Analog-FFT may be more energy efficient than the FFT. In some embodiments, β(m) is an increasing function of m. More energy may be used to compute a matrix-vector product on a larger photonic accelerator.

In some embodiments, the amount of power used to compute an analog portion of the Hybrid-Analog-FFT algorithm is independent of input signal size. Where a signal is of length n and the photonic accelerator of size m, the Hybrid-Analog-FFT algorithm may create n/m vectors. The power drawn by the hybrid processor may be the same for the matrix-vector product computation of each vector, and therefore may remain constant.

In certain applications, a hybrid processor may provide improved performance compared with a conventional fully-digital processor. According to some embodiments, performance analysis may be similar to that of the energy analysis. In some embodiments, a run time, R, to compute the FFT may be provided according to Equation 12.

$${R}_{F F T} ( n ) \approx γ n {log}_{2} ( n ) \qquad ( 12 )$$

In Equation 12 where γ is the amount of digital operations per second. In contrast, when setting aside the amount of time to compute ADC, DAC, and transfer data to and from the photonic accelerator, the run time to compute the Hybrid-Analog-FFT is provided according to Equation 13.

$${E}_{HA - FFT} ( n ) \approx γ n {log}_{2} ( \frac{n}{m} ) + ν \frac{n}{m} \qquad ( 13 )$$

In Equation 13, v is the amount of time to compute a photonic accelerator matrix-vector product. Therefore, a Hybrid-Analog-FFT algorithm may run faster than a conventional fully-digital FFT when the inequality provided according to Equation 14 is satisfied.

$$ν < γ m {log}_{2} ( m ) \qquad ( 14 )$$

According to some embodiments, energy and performance of an Adjustable-High-Resolution-Analog DFT algorithm compares with a traditional fully-digital FFT may relate to the size of the photonic accelerator, m, relative to the length of the signal, N. In some embodiments, The amount of energy used for the FFT approach is approximately E_{FFT}(N)≈am log₂(N), as previously provided according to Equation 8. In some embodiments, an amount of energy used by the Adjustable-High-Resolution-Analog DFT algorithm is provided according to Equation 15.

$${E}_{A HRA - FFT} ( N ) = β ⌈ N / m ⌉ < β ( N / m + 1 ) \qquad ( 15 )$$

Thus, E_{AHRA-FFT}(N) may become more energy efficient than a conventional fully-digital FFT when the inequality provided according to Equation 16 is satisfied.

$$β < α \frac{{m}^{2} {log}_{2} ( N )}{N + m} \qquad ( 16 )$$

The same analysis shows that the performance of the Adjustable-High-Resolution-Analog DFT algorithm may be faster than a conventional fully-digital FFT when the inequality provided according to Equation 17 is satisfied.

$$ν < γ \frac{{m}^{2} {log}_{2} ( N )}{N + m} \qquad ( 17 )$$

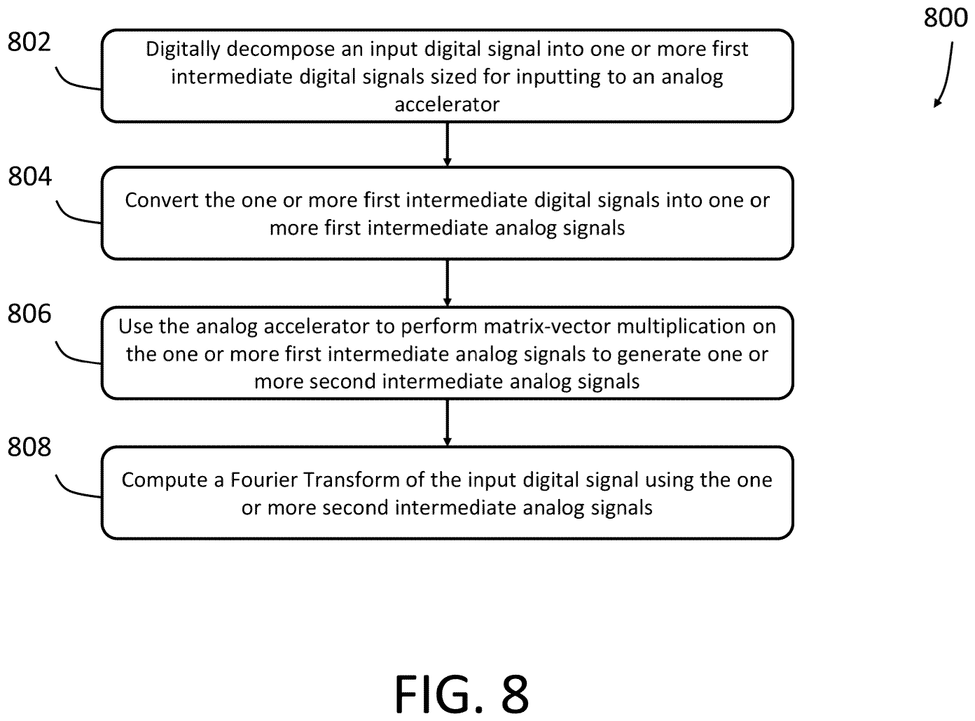

According to some embodiments, FIG. 8 shows an exemplary process flow of a method of performing hybrid analog-digital Fourier Transforms, which may be carried out using a hybrid analog-digital processor. Such a hybrid analog-digital processor (an example of which is shown in FIG. 1B) may comprise a digital processor, an analog accelerator (such as a photonic accelerator), a DAC, and an ADC.

Process flow 800 includes act 802, act 804, act 806, and act 808. At act 802 of process flow 800, a digital processor may digitally decompose an input digital signal into one or more first intermediate digital signals sized for inputting to an analog accelerator. At act 804 of process flow 800, a DAC may convert the one or more first intermediate digital signals into one or more first intermediate analog signals. At act 806 of process flow 800, the analog accelerator may perform matrix-vector multiplication on the one or more first intermediate analog signals to generate one or more second intermediate analog signals. At act 806 of process flow 800, the hybrid analog-digital processor may compute a Fourier Transform of the input digital signal using the one or more second intermediate analog signals.

### V. Definitions

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The definitions, as defined and used herein, should be understood to control over dictionary definitions, definitions in documents incorporated by reference and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately,” “substantially,” and “about” may be used to mean within ±10% of a target value in some embodiments. The terms “approximately,” “substantially,” and “about” may include the target value.

Use of ordinal terms such as “first,” “second,” “third,” etc., in the claims to modify a claim element does not by itself connotate any priority, precedence, or order of one claim element over another or the temporal order in which acts of a method are performed, but are used merely as labels to distinguish one claim element having a certain name from another claim element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

What is claimed is:

1. A hybrid analog-digital processor for performing Fourier Transforms, the hybrid analog-digital processor comprising:
a digital processor configured to decompose an input digital signal into one or more first intermediate digital signals sized for inputting to an analog accelerator;
a digital-to-analog converter configured to convert the one or more first intermediate digital signals into one or more first intermediate analog signals; and
the analog accelerator, wherein the analog accelerator is configured to perform matrix-vector multiplication on the one or more first intermediate analog signals to generate one or more second intermediate analog signals,
wherein the hybrid analog-digital processor is configured to compute a Fourier Transform of the input digital signal using the one or more second intermediate analog signals.

2. The hybrid analog-digital processor of claim 1, wherein:
the analog accelerator comprises a photonic accelerator configured to perform the matrix-vector multiplication using light.

3. The hybrid analog-digital processor of claim 1, wherein:
the hybrid analog-digital processor further comprises an analog-to-digital converter; and
computing the Fourier Transform of the input digital signal using the one or more second intermediate analog signals comprises:
using the analog-to-digital converter to convert the one or more second intermediate analog signals into one or more second intermediate digital signals; and
composing the one or more second intermediate digital signals into the Fourier Transform of the input digital signal.

4. The hybrid analog-digital processor of claim 3, wherein:
performing the matrix-vector multiplication on the one or more first intermediate analog signals to generate the one or more second intermediate analog signals comprises:
multiplying the one or more first intermediate analog signals by a Fourier Transform matrix.

5. The hybrid analog-digital processor of claim 4, wherein:
the Fourier Transform matrix comprises real and imaginary components; and
composing the one or more second intermediate digital signals into the Fourier Transform of the input digital signal comprises:
composing real and imaginary components of the one or more second intermediate digital signals.

6. The hybrid analog-digital processor of claim 5, wherein:
converting the one or more first intermediate digital signals into the one or more first intermediate analog signals comprises:
mapping the one or more first intermediate digital signals into real and imaginary components of the one or more first intermediate analog signals.

7. The hybrid analog-digital processor of claim 4, wherein:
decomposing the input digital signal into the one or more first intermediate digital signals sized for input into the analog accelerator comprises:
providing the one or more first intermediate digital signals with a length m; and
multiplying the one or more first intermediate analog signals by the Fourier Transform matrix comprises:
multiplying the one or more first intermediate analog signals by an m-dimensional Fourier Transform matrix.

8. The hybrid analog-digital processor of claim 7, wherein:
the digital processor is further configured to:
batch the one or more first intermediate digital signals into a 2D digital array;
converting the one or more first intermediate digital signals into one or more first intermediate analog signals comprises:
converting the 2D digital array into a 2D analog array; and
multiplying the one or more first intermediate analog signals by an m-dimensional Fourier Transform matrix comprises:
multiplying the 2D analog array by the m-dimensional Fourier Transform matrix.

9. The hybrid analog-digital processor of claim 4, wherein:
multiplying the one or more first intermediate analog signals by a Fourier Transform matrix comprises:
multiplying the one or more first intermediate analog signals by a submatrix of a full Fourier Transform matrix, the submatrix corresponding to a frequency bin of interest.

10. The hybrid analog-digital processor of claim 1, wherein:
decomposing the input digital signal into the one or more first intermediate digital signals sized for inputting to an analog accelerator comprises:
decomposing the input digital signal using a radix-2 Fourier Transform algorithm until the one or more first intermediate digital signals has a size equal to a size of the analog accelerator.

11. A method for performing hybrid analog-digital Fourier Transforms, the method comprising:
digitally decomposing an input digital signal into one or more first intermediate digital signals sized for inputting to an analog accelerator;
converting the one or more first intermediate digital signals into one or more first intermediate analog signals;
using the analog accelerator to perform matrix-vector multiplication on the one or more first intermediate analog signals to generate one or more second intermediate analog signals; and
computing a Fourier Transform of the input digital signal using the one or more second intermediate analog signals.

12. The method of claim 11, wherein:
the analog accelerator comprises a photonic accelerator; and
performing the matrix-vector multiplication comprises:
performing the matrix-vector multiplication using light.

13. The method of claim 11, wherein:
computing the Fourier Transform of the input digital signal using the one or more second intermediate analog signals comprises:
converting the one or more second intermediate analog signals into one or more second intermediate digital signals; and
composing the one or more second intermediate digital signals into the Fourier Transform of the input digital signal.

14. The method of claim 13, wherein:
performing the matrix-vector multiplication on the one or more first intermediate analog signals to generate the one or more second intermediate analog signals comprises:
multiplying the one or more first intermediate analog signals by a Fourier Transform matrix.

15. The method of claim 14, wherein:
the Fourier Transform matrix comprises real and imaginary components; and
composing the one or more second intermediate digital signals into the Fourier Transform of the input digital signal comprises:
composing real and imaginary components of the one or more second intermediate digital signals.

16. The method of claim 15, wherein:
converting the one or more first intermediate digital signals into the one or more first intermediate analog signals comprises:
mapping the one or more first intermediate digital signals into real and imaginary components of the one or more first intermediate analog signals.

17. The method of claim 14, wherein:
decomposing the input digital signal into the one or more first intermediate digital signals sized for input into the analog accelerator comprises:
providing the one or more first intermediate digital signals with a length m; and
multiplying the one or more first intermediate analog signals by the Fourier Transform matrix comprises:
multiplying the one or more first intermediate analog signals by an m-dimensional Fourier Transform matrix.

18. The method of claim 17, wherein:
the method further comprises:
batching the one or more first intermediate digital signals into a 2D digital array;
converting the one or more first intermediate digital signals into one or more first intermediate analog signals comprises:
converting the 2D digital array into a 2D analog array; and
multiplying the one or more first intermediate analog signals by an m-dimensional Fourier Transform matrix comprises:
multiplying the 2D analog array by the m-dimensional Fourier Transform matrix.

19. The method of claim 14, wherein:
multiplying the one or more first intermediate analog signals by a Fourier Transform matrix comprises:
multiplying the one or more first intermediate analog signals by a submatrix of a full Fourier Transform matrix, the submatrix corresponding to a frequency bin of interest.

20. The method of claim 11, wherein:
decomposing the input digital signal into the one or more first intermediate digital signals sized for inputting to an analog accelerator comprises:
decomposing the input digital signal using a radix-2 Fourier Transform algorithm until the one or more first intermediate digital signals has a size equal to a size of the analog accelerator.
